(19) United States
(12) Patent Application Publication
(10) Pub. No.: US 2010/0032948 A1
(43) Pub. Date: Feb. 11, 2010

(54) Method and apparatus for operating and controlling airborne wind energy generation craft and the generation of electrical energy using such craft

(76) Inventor: JoeBen Bevirt, Santa Cruz, CA (US)

Correspondence Address: MICHAEL A. GUTH, 2-2905 EAST CLIFF DRIVE, SANTA CRUZ, CA, 95062, US

(21) Appl. No.: 12/459,017

(22) Filed: Jun. 25, 2009

Related U.S. Application Data
(60) Provisional application No. 61/075,613, filed on Jun. 25, 2008.

(51) Int. Cl. F03D 9/00; F03D 7/00

(52) U.S. Cl. 290/44; 290/55

(57) ABSTRACT

The invention described herein relates generally to wind power generation. In particular, the invention relates to devices and methods used for launching and retrieving wind energy generating craft as well as novel constructions of such craft. Additionally, novel structures for tethers and tether operation is disclosed. Also, methods and apparatus for power generation are described. The craft described herein are intended for electrical power generation utilizing the wind energy collected from air currents.

### CROSS-REFERENCE TO RELATED APPLICATIONS

This Application claims priority to U.S. Provisional Patent Application No. 61/075,613, filed Jun. 25, 2008, to Bevirt.

### TECHNICAL FIELD

The invention described herein relates generally to wind power generation. In particular, the invention relates to devices and methods used for launching and retrieving wind energy generating craft as well as novel constructions of such craft. Additionally, novel structures for tethers and tether operation is disclosed. Methods and apparatus for controlling wind energy craft are disclosed. Methods and apparatus for generating and storing wind generated energy are also disclosed. The craft described herein are intended for electrical power generation utilizing wind energy.

### BACKGROUND

The generation of electricity from conventional ground based devices has been under study for some time. However, such ground based electrical generation devices are somewhat hampered by the low power density and extreme variability of natural wind currents (in time and space) at low altitudes. For example, typical average energy density at the ground is less than about 0.5 watts per square meter (W/m²). Higher altitudes offer more promising energy densities.

The inventors note that when an aircraft gets above a few hundred meters above the ground, increased wind currents are commonly found. Moreover, when a boundary layer (at an altitude of about 1 kilometer) is exceeded, relatively windy conditions can be obtained on a fairly consistent basis. Moreover, when very high altitudes are reached, the jet stream is encountered. This is advantageous because jet stream energy densities can average about 10 W/m². Thus, at higher altitudes wind generated power becomes an economically feasible alternative using existing technologies to generate power on an economically sustainable scale. The apparatuses and methods disclosed here present embodiments that can access high altitude wind currents and use the higher energy densities to produce power.

Others have explored the idea of using tethered “kites” to generate power. Examples of this principle are described in many papers. In one example Miles Loyd describes an approach for generating “Crosswind Kite Power” (J. of Energy Vol. 4, No. 3. May-June 1980). Also, “Optimal Crosswind Towing and Power Generation with Tethered Kites” (Williams et al., Journal of Guidance, Control, and Dynamics, Vol. 31, No. 1, January-February 2008) addresses the concept. As does “Optimal Control for Power Generating Kites” (Houska B., Diehl M., Internal Report 07-98, ESAT-SISTA, K. U. Leuven (Leuven, Belgium), 2007. Accepted for publication in European Control Conference, Kos, 2007). These publications, and others, provide much explanatory background and are hereby incorporated by reference.

However, the inventors have determined that many problems needed to be solved and much work was needed beyond the basic ideas discussed in the papers above. Accordingly, the present disclosure examines some of these problems and suggests several novel solutions to these and other problems. Accordingly, embodiments of the invention present solutions to some of the extent problems associated with existing wind powered electricity generation approaches.

### SUMMARY OF THE INVENTION

In accordance with the principles of the present invention, a variety power generation and flight control systems for wind power generating kites and aircraft are disclosed.

In one embodiment, the invention comprises a craft (kite, glider, etc.) tethered to a ground based energy generation device using an aerodynamic tether. The craft can comprise a “kite” configured with an airfoil and tethered to the ground based power generator. The craft and tether are configured to pull on the tether during a flight pattern calculated to pull on the tether that is connected to the generator to enable power generation. In some embodiments, the tether is attached to the kite at various optimized locations that can result in reduced drag and weight for the kite. Additionally, certain tether and bridle embodiments can be used to enhance kite fight characteristics. By moving the bridle or an attachment point from one side to another the roll angle of the kite and other aerodynamic properties of the kite can be altered to control the kite.

The invention further includes a discussion of various launch and/or recovery platforms suitable for launching and or landing craft of the invention. In some embodiments, both launch and take-off can be facilitated by a movable launch platform that can be used to launch the craft upward at increased velocity. Such platforms can be land or water based.

Another embodiment includes a power generation system designed to take advantage of the wind power is disclosed. A craft is configured to generate power as the craft is pulled away from the generator by the wind. To offset power generation losses when the craft is reeled back in a flywheel is used to sustain power generation. The inventors have contemplated a clutch actuated flywheel used to generate power while the craft is reeled back in. Also, the inventor contemplates a two stage reel assembly designed with a high tension first stage attached to the craft and lower tension second stage coupled to a back end of the tether. The inventors have contemplated numerous gearing assemblies and multi-generator approaches to power generation.

The inventor contemplates bridle and tether assemblies which can include aerodynamic elements to increase tether or bridle performance and stability during use. Also, the inventor contemplates a modular and sectional tether that can be assembled together from numerous smaller segments.

In further embodiments the tether system can be arranged so that a multi-craft system is enabled. Such systems can include arrangements and mechanisms configured to alter the kite flight profile and/or the spacing between the associated kites. Moreover, emergency decoupling mechanisms are contemplated and described.

Novel pulley assemblies capable of traversing airfoil-shaped tethers are also described.

In another embodiment, a novel tether configuration is disclosed. In one embodiment, a portion of the tether is aerodynamically stable having an airfoil shaped cross-section. Another portion of the tether is robust and inelastic designed for enhanced strength such that it can be continuously be reeled and unreeled from a reel.

These and other aspects of the present invention are described in greater detail in the detailed description of the drawings set forth hereinbelow.

### BRIEF DESCRIPTION OF THE DRAWINGS

The following detailed description will be more readily understood in conjunction with the accompanying drawings, in which:

FIGS. 1(a)-1(b) are simplified block diagrams illustrating aspects of wind energy power generation systems.

FIGS. 2(a)-2(d) are tether and bridle embodiments and attachment arrangements articulation mechanisms used in a wind power generation system in accordance with the principles of the invention.

FIGS. 3(a)-3(g) are views of various embodiments of water-based and land-based launch and recovery platforms and approaches for wind power generation craft in accordance with the principles of the invention.

FIGS. 4(a)-4(e) are views of various embodiments of anchoring and power generation apparatus including at least one spool and can include a flywheel suitable for use with power generation craft and moreover describe certain gearing arrangements in accordance with the principles of the invention.

FIGS. 5(a)-5(k) are perspective and cross-section views of various embodiments of tethers constructed in accordance with the principles of the invention.

FIGS. 6(a)-6(b) are views of a modular tether embodiment capable of assembly into long tethers in accordance with the principles of the invention.

FIGS. 7(a)-7(d) are views of a multi-craft tether embodiment in accordance with the principles of the invention.

FIGS. 8(a)-8(b) are views of another multi-craft tether embodiment in accordance with the principles of the invention.

FIG. 9 is a simplified view of a motorized pulley embodiment configured in accordance with the principles of the invention.

FIG. 10 is a simplified view of a two-stage tether system having an aerodynamic portion and an inelastic and structurally robust portion.

FIG. 11 is a perspective view of a craft having auxiliary power generation capacity and storage in accordance with the principles of the invention.

It is to be understood that, in the drawings, like reference numerals designate like structural elements. Also, it is understood that the depictions in the Figures are not necessarily to scale.

### DETAILED DESCRIPTION OF THE DRAWINGS

The present invention has been particularly shown and described with respect to certain embodiments and specific features thereof. The embodiments set forth herein below are to be taken as illustrative rather than limiting. It should be readily apparent to those of ordinary skill in the art that various changes and modifications in form and detail may be made without departing from the spirit and scope of the invention.

The following detailed description describes various approaches for putting aloft and recovering wind-energy harvesting devices. Such devices can be employed at many altitudes, but of particular utility when used to generate electrical power when positioned above the boundary layer (e.g., above an altitude of about 1 kilometer). Additionally, some embodiments can be used to exploit the high velocity winds present in the jet stream. Some of the embodiments described here make use of kites or gliders having airfoil lifting members. Such craft can also make use of launch and retrieval platforms including raised platforms that are elevated some distance above the ground.

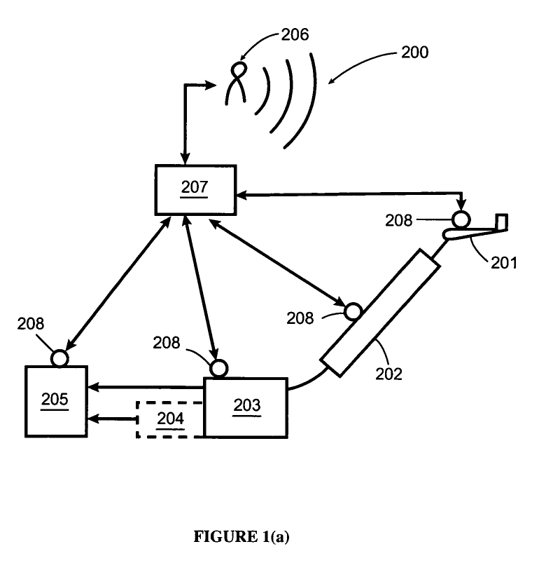

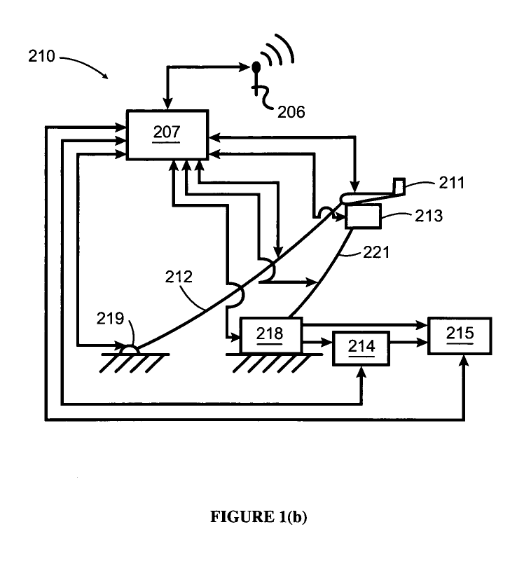

Air currents a few hundred meters above the ground generally have increased wind velocities that can be well exploited by the craft of the present invention. Such wind velocities can range from the relatively low 5 kph (kilometers per hour) winds to those of the jet stream. The jet stream includes a family of fast flowing, relatively narrow air currents found in the atmosphere around 10 kilometers above the surface of the Earth. The wind velocity in the jet stream, although variable, is generally quite high. These jet streams present a vast untapped potential for wind generated energy. The inventor describes a number of energy generation approaches in this patent. FIG. 1(a) schematically represents an example system enabling energy generation in accordance with the principles of the invention. This system 200 described herein is not intended to be limiting, but rather provides a useful starting place to describe the many attributes of the disclosed invention. The system 200 includes a flyable aircraft 201 that is attached to an energy generation station 203 using a tether 202. Wind energy captured by the craft 201 is transferred to the energy generation station 203 using the tether 202. Generally, forces exerted by the tether 202 are harnessed and used to generate electricity at the generator 203. The system can further include an energy storage system 204 that forms part of the energy generation system 203. In alternative approaches, the energy storage system 204 can be separate from the energy generation system 203. Energy produced by the system 200 or stored 204 can be supplied to a distribution system 205 which can deliver the energy as needed. A typical example of such can be an electrical distribution network or power grid. Also, an atmospheric monitoring system 206 can be included to monitor weather, wind, and flight conditions. Such monitoring can include real-time information as well as forecasting information. The monitoring system can be ground-based, seaborne, airborne, or even space-based. Also, each of the disclosed systems 201, 202, 203, 204, 205, 206 can include sensor devices 208 that monitor the performance of each portion of the system 200 to provide information to a control system 207 that can adjust flight parameters and adapt to varying and changing conditions. This integrated system 200 can be used to among other things, optimize power generation, more efficiently distribute power, enhance system performance, adapt to variations in weather conditions, control the flight profiles of craft, adapt to system needs, local conditions, and a myriad of other performance and optimization information.

Another associated approach for harvesting wind energy applies to airborne wind turbine systems. FIG. 1(b) schematically depicts one such system. This system 210 described herein is not intended to be limiting, but rather provides a useful starting place to describe the many attributes of the disclosed invention. The system 210 includes a flyable aircraft 211 that includes an energy generation system 213 capable of generating electricity. This is commonly a turbine system 213 carried and kept aloft by the aircraft 211. The craft 211 is anchored to the ground 219 using a tether 212. Wind energy captured by the energy generation system 213 of craft 211 is transferred to a ground station 218 using an electrical transmission line 221. In one application the electrical transmission line 221 is supported by the tether 212. In another approach, energy generated can be transmitted to the ground station using an alternative carrier system (e.g., microwave generation and receiving stations). The system can further include an energy storage system 214. Energy produced by the system 210 or stored 214 can be supplied to a distribution system 215 which can deliver the energy as needed. A typical example of such can be an electrical distribution network or power grid. Also, an atmospheric monitoring system 206 can be included to monitor weather, wind, and flight conditions. Such monitoring can include real-time information as well as forecasting information. The monitoring system can be ground-based, seaborne, airborne, or even space-based. Also, each of the disclosed system elements 206, 211, 212, 213, 214, 215, 218, can include sensor devices S that monitor the performance of each portion of the system 210 to provide information to a control system 207 that can adjust power generation parameters and flight parameters and adapt to varying and changing conditions. This integrated system 210 can be used to among other things, optimize power generation, more efficiently distribute power, enhance system performance, adapt to variations in weather conditions, control the flight profiles of craft, adapt to system needs, local conditions, power generation concerns, and a myriad of other performance and optimization information.

In one approach a craft or “kite” 201 is attached to a long tether 202 and allowed to gain altitude. As the kite 201 gains altitude it applies forces on the tether. As the force applied by the kite continues, more and more of the tether 202 is played out. The tether can be attached to an energy generator 203 which generates electrical energy as a tether is played out. In a typical embodiment, the generator 203 includes a large reel of tether 202 which spins in one direction as the tether is played out under force generated by wind energy against the “kite” 201. In certain embodiments, the reel (part of the energy generator 203) forms part of an electromagnetic power generator. During operation as the tether is played out, the reel spins enabling electrical power generation. Periodically, the kite can change its flight profile (e.g., angle of attack or other flight characteristics) to remove tension from the tether. When the tension is removed, the tether can be reeled in using relatively little energy. One method of reeling the kite in employs a small motor. Once the kite is reeled in a desired amount, the kite is maneuvered into a different flight profile enabling the wind generated force to again be applied to the kite. Various flight patterns can be used to effectively generate power. Examples include crosswind flight patterns such as “figure eight” patterns and so on. In any case the playing out and reeling in of the tether can be applied repeatedly for long periods of time enabling extensive power generation. The kites are generally flown at altitudes calculated to obtain the highest efficiencies for energy generation although any altitude can be selected. For example, the inventor contemplate that energy harvesting can be efficient at altitudes as lower as a few hundred meters with certain advantages also accruing at altitudes in the range of a few kilometers (e.g., 1-2 kilometers). However, the inventors expressly point out that the devices and systems disclosed herein are not to be confined to operation at any particular altitude. For example, the inventors specifically contemplate higher altitude operations an point out that certain advantages accrue when the kite is flown at jet stream altitudes. The power generation attributes of these craft can be enhanced by adding ancillary energy generation mechanisms such large solar panels to the craft and/or tethering systems. Also, auxiliary wind turbines can be mounted at various locations on the craft.

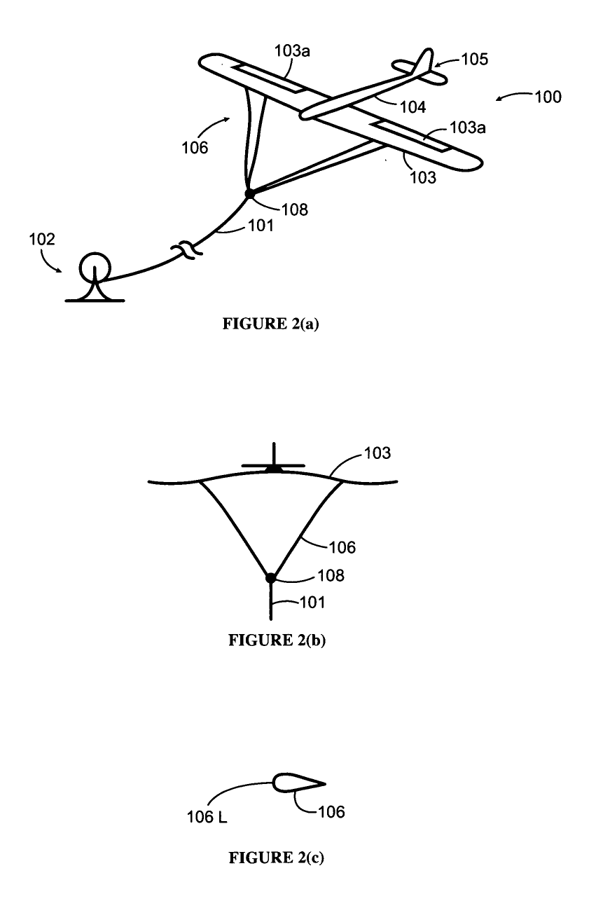

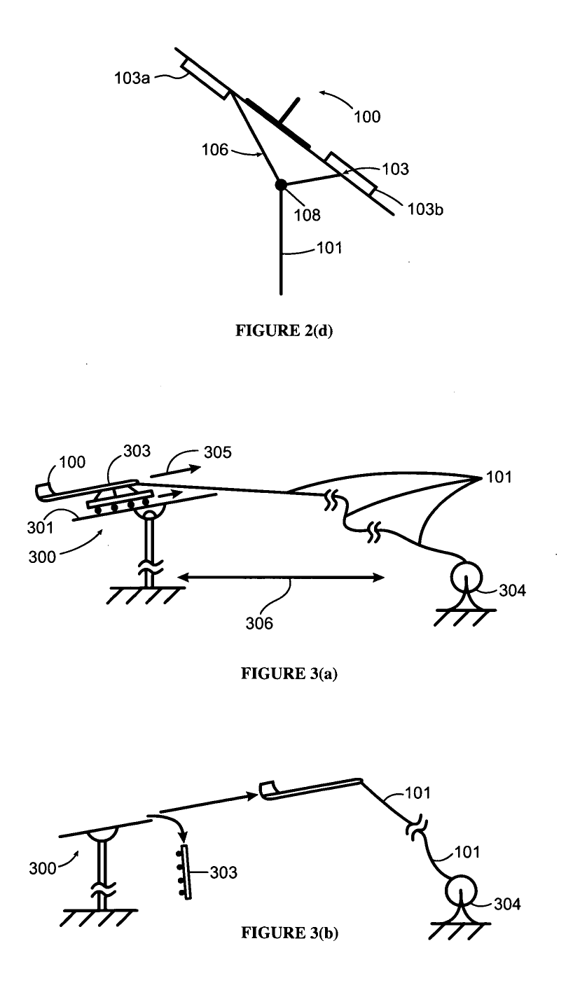

As shown in FIG. 2(a), the inventor contemplates a kite 100 configured to generate wind energy. The kite 100 can be constructed in many different configurations having a wide range of aerodynamic and flight characteristics and properties. Accordingly, the kite 100 depicted here as a substantially aircraft-shaped apparatus should serve as an example, but kites constructed in accordance with the principles of the invention are not limited to the depicted exemplar shape. The kite 100 is attached to a tether 101 which is moored to an energy generator 102 which can be located on the ground.

In the depicted embodiment, the kite 100 includes a wing 103 mounted to a minimal fuselage 104 which further includes an empennage 105 for added stability. In the depicted embodiment, the tether 101 is attached to the craft using a bridle assembly 106, which in this depiction is affixed to the wings to provide a stable attachment to the craft 100. Many different bridle 106 configurations can be used to secure the craft 100 to the tether 101 and the invention should not be limited to only the depicted embodiments. The inventors contemplate that for enhanced performance the wing 103 of the kite 100 can be configured with ailerons 103a and/or other control surfaces. Additionally, although rigid wings 103 are believed to provide the best performance the inventor appreciates that non rigid wings can be employed in some embodiments.

In some embodiments the kite 100 turns and maneuvers similar to a glider. In other words control surfaces can be used to maneuver the craft 100. In one particular approach, FIG. 2(d) shows the implementation of ailerons 103a to bank the craft.

The applicants further point out that the bridle can include an articulation mechanism (schematically depicted as 108). This mechanism can be used to enhance or replace portions of the control system to enable the bridle to initiate and control the roll of the craft 100. Additionally, the bridle 106 and mechanism 108 can be configured to alter the angle of attack for the airfoil 103.

With reference to FIG. 2(b), the inventors point out that the bridle 106 can be attached at any point on the airfoil 103. The bridle 106 can be attached at the ends of the airfoil 103 or at points between the tip of the airfoil 103 and the fuselage 104. The depicted embodiment shows a bridle 106 attached at a point inward from the wingtip. This construction enables a lighter and thinner spar to be used in the construction of the airfoil 103. This has the advantage of significantly lowering the drag induced by the wing 103. Also, the inventors contemplate that, as shown in FIG. 2(c), an airfoil shaped bridle 106 can be used. FIG. 2(c) is a cross-section view of a bridle 106 such as shown in FIG. 2. Such a shape provides streamlining and reduced drag. Additionally, the shape can be optimized to provide increased stability to the bridle 106. In the depicted embodiment the leading edge 106L is typically oriented toward the front of the craft 100.

With continued reference to FIGS. 2(a)-2(c) and with further reference to FIG. 2(d), the inventors illustrate that in one embodiment the articulation mechanism 108 enables the bridle 106 to control the roll of the craft 100. It is further contemplated that ailerons 103a can be used to enable roll. Although the inventors specifically contemplate embodiments that do not make used of ailerons 103a. In another embodiment, the articulation mechanism 108 can be used without ailerons of even other control surfaces if desired. In some embodiments, the articulation mechanism 108 can be a pulley or other similar apparatus. A motorized winch apparatus could also be used. The idea being that the pulley is moved toward one wingtip or the other depending on the direction and magnitude of roll desired. In effect, the pulley lengthens one part of the bridle and shortens the other. The depiction of FIG. 2 shows a craft 100 as viewed from head on showing the effect when the pulley is moved from the centerline to a direction to the right of the observer. This makes the left side (as viewed from an observer directly ahead) roll upward. A reversed pulley motion causes the opposite effect. In other embodiments the articulation mechanism 108 can also be used alter the angle of attack of the craft 100. For example, because the articulation mechanism 108 is arranged under the center of lift for the airfoil 103 the angle of attack can be relatively easily altered by moving the articulation mechanism 108 forward or backward. The inventor understands that many methods known to those having ordinary skill in the art enable the tether to be moved back and forward as needed. For example, a small motor can be employed and actuated using wireless of wired signal.

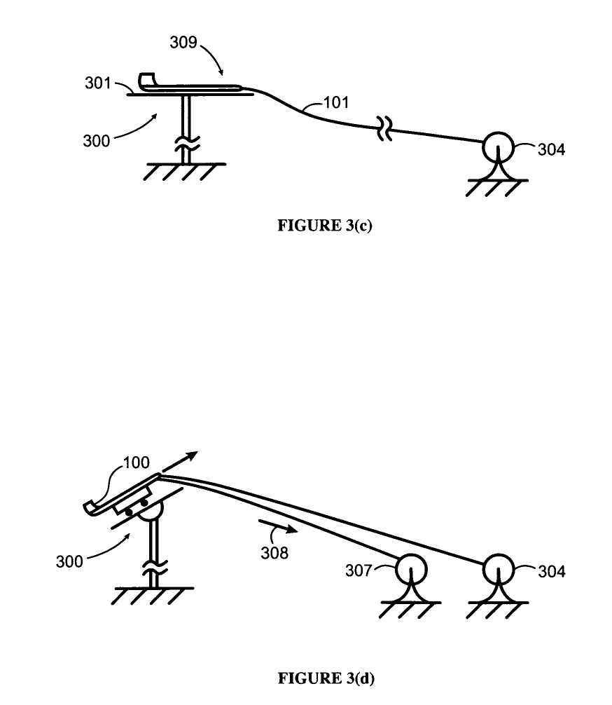

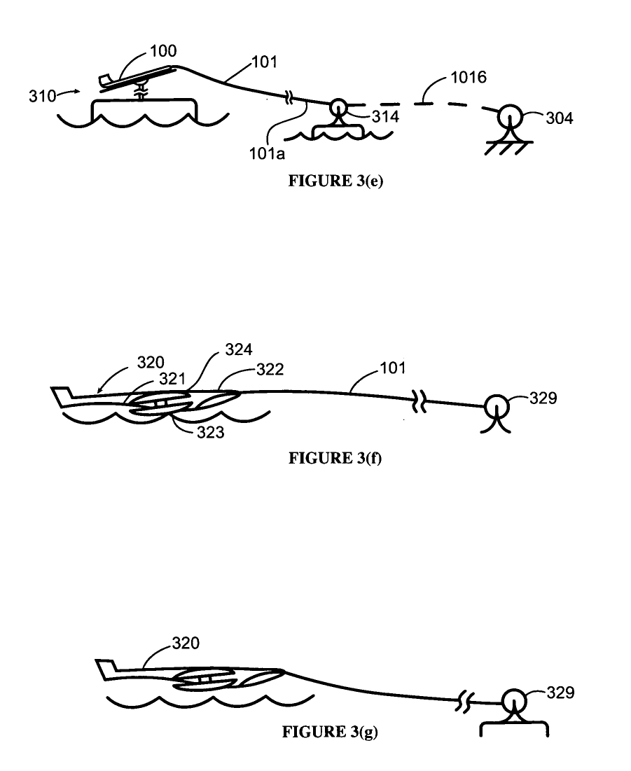

One of the difficulties with the use of such craft 100 is the effort needed to reach take-off velocity. Another is the relative vulnerability of the tether 105 to damage, especially during the delicate take off and landing processes. One embodiment of the invention is configured so that a launch platform is used to facilitate take off and landing of the craft. With reference to FIG. 3(a) an example craft 100 is shown tethered 101 to a launch apparatus 304 (which can be the spool of the energy generator 102 or another ground based motive device) and resting on a launch platform 300. In general, the launch apparatus 304 is positioned a considerable distance 306 from the platform 300. The distance 306 can be, for example, three to five times the wingspan of the craft 100 or even longer as needed. When operated as a launch mechanism, a tether 101 can be reeled in by the spool 304 at a sufficiently high rate of speed such that the craft exceeds stall speed and becomes airborne by the time it reaches the end of the platform 300 or shortly thereafter. The platforms can be quite large, 100 meters and greater across.

Additionally, the platform 300 itself can be flexibly employed as both a take off and landing medium. The platform 300 depicted here has an angled launch surface 301. Additionally, it can be raised some distance from the ground, for example, by mounting on a support pillar 302. The pillar 302 is used to elevate the launch surface 301 a suitable distance above the ground. In the depicted embodiment, the pillar 302 holds the launch surface 301 about 20-100 meters off the ground. If for example, a 100 meter tower is used to support the launch surface 301, better wind conditions can be obtained enabling easier landing and take off.

Again referring to FIG. 3(a), in the depicted embodiment, the launch surface 301 can be arranged at an angle from the horizontal enabling the craft 100 to be launched at an upward angle. Moreover, take-off can be assisted or replaced by other launch devices. For example, as depicted here, the craft 100 can rest on a movable launch sled 303. Such a sled can comprise a cart with wheels configured to support the craft and roll easily as it is accelerated to take-off velocity. The inventors contemplate many other types of launch vehicles or launch apparatus. The sleds can be rail mounted, or on a skids, or a number of other devices capable of accelerating the craft 100 to the necessary velocity to enable a take-off. The sled 303 can also be detachable from the craft 100 upon take off. It is to be noted that a wide variety of detachable launch sleds 303 can support the craft 100 during launch. Additionally, in some embodiments the craft can include permanent landing gear if desired. The inventor points out that many other approaches can be used to enable the craft to freely move over the launch platform 301 and this disclosure is not intended to be limiting. The motive force behind the launch can include a number of methods and devices.

FIG. 3(b) shows that as the craft 100 clears the end of the platform 300 the sled 303 drops away separating from the craft 100. Thus, the added weight of a landing/take-off gear can be dispensed with. Of course in alternative embodiments, landing gear can be retained. Once airborne, the craft 100 is flown to its desired height while extending the tether 101 which is typically used to generate energy as the tether is reeled out.

As mentioned above, the inventor contemplates that many modes of launch can be employed to launch the craft from the platform (or from the ground). For example, instead of being pulled by the tether, the launch acceleration can be supplied by a powered sled 303 (or cart) that is accelerated while the kite is positioned on its back. Steam driven and pneumatic catapult launchers are contemplated, as are line tension catapults. Additionally, as illustrated in FIG. 3(d), a pull line 307 separate from the tether 101 can be attached to the front of the craft 100 and accelerated (e.g., in a direction indicated by the arrow 308) to a high speed which will propel the craft 100 above the stall speed and enable take off where it lifts itself and the tether. In another approach, the motive force can be applied by a rocket motor which can be attached to the craft or sled to accelerate to the desired velocity and then be discarded. The inventor also contemplates that an aircraft such as a tow plane can be used to tow the craft 100 to a desired altitude. Alternatively, a large balloon or airship could be used to float or tow the craft 100 to a desired altitude.

Additionally, in some embodiments, the platform can also serve as a landing platform 300. As depicted in FIG. 3(c), the platform can be rotated (for example, by rotating in the direction of the arrow 309) into a more horizontal landing configuration. In such a configuration the craft 100 can be flown is a desired approach pattern to enable a landing on the platform. The platform 300 can be configures with special landing surfaces that enable soft and damage free landings. Also, arrester lines could be used. Also, sleds such as those used to launch the craft could be used to assist in landing the craft. In some approaches, the sled could be brake assisted to slow the craft and sled during landing. In some embodiments, the landing surface 301 can swiveled to a flat profile to enable suitable approaches by craft 100. For example, the platform can be rotated to a desired configuration to ease landings.

Additionally, the inventors contemplate the platform itself may be movable to facilitate landing. Also. This may be facilitated by a large movable land based platform. And also, a water based platform like a barge or boat can be used to launch and retrieve the craft. Also, the craft may be configured as a buoyant structure enabling water borne take off and landings. For example, reference is made to FIGS. 3(e)-3(f). In one case illustrated by FIG. 3(e), a large movable launch platform 310 supports a kite or other craft 100. In one example, the movable launch platform 310 is a water borne platform like a barge or other suitable ship. The craft 100 is mounted on the platform 310 in readiness for launch. A tether 101 is attached to the craft 100. The tether is further attached with a spool. In one embodiment, the tether 101, 101a is attached to a water based spool 314 which can be used to pull the craft 100 to a sufficient launch velocity. The tether 101, 101a also operates the craft 100 in flight. In another related approach, the tether 101, 101b is attached to a land based spool 315 which can be used to pull the craft 100 to a sufficient launch velocity.

In another approach, such as depicted in FIGS. 3(f) and 3(g), a craft 320 configured for water takeoff and/or landing can be used. Such a craft 320 could be configured similar to a seaplane. In some embodiments, the fuselage could be configured for water landing and also pontoons could be attached to various locations (fuselage, wings etc.). In one example, the fuselage 321 could have a sleek boat-shaped nose 322 and small pontoons 323 could be mounted to support the wings 324. Such a configuration would enhance the ability of the craft 320 to conduct water borne take-off and landing. The aircraft 320 could be accelerated to a desired speed using any of the previously discussed approaches as well as others. For example, a tether 101 could be mounted to a spool 329 that is mounted on land or water. The tether 101 could be reeled in at a rate of speed calculated to enable the craft 320 to take off, By a similar token, as schematically depicted in FIG. 3(g), the spool can be used to facilitate a water borne landing. The spool could be land-based. However, the inventor contemplates that a water-based spool 329 can also be employed. This will enable the spool to be move to take advantage of the best landing conditions. Also, the spool 329 could be mounted on a large rotatable platform to enable the spool 329 to be swiveled to take full advantage of the local conditions. In another approach a water-borne spool 329 could be mounted on a movable support such as a ship or barge. Thus, the ship could be moved or swiveled to enable optimized landing conditions. As with the other approaches disclosed herein, these described embodiments are intended to be illustrative rather than limiting and are intended to illustrate a general principle that has many other possible implementations.

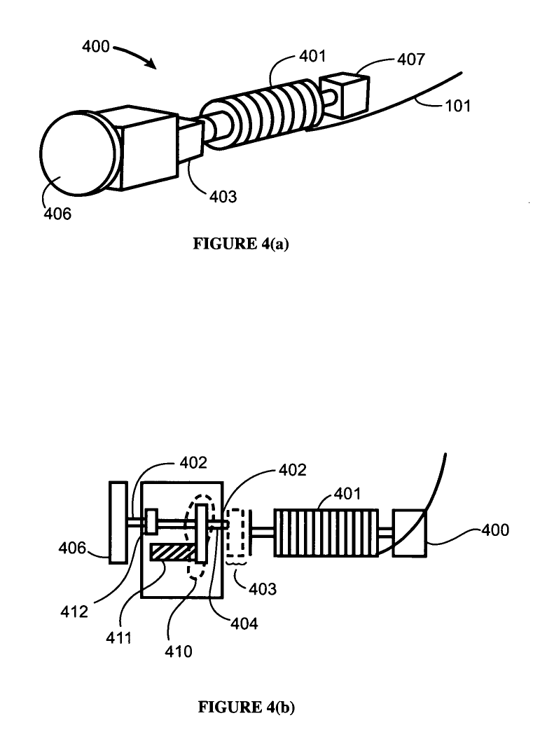

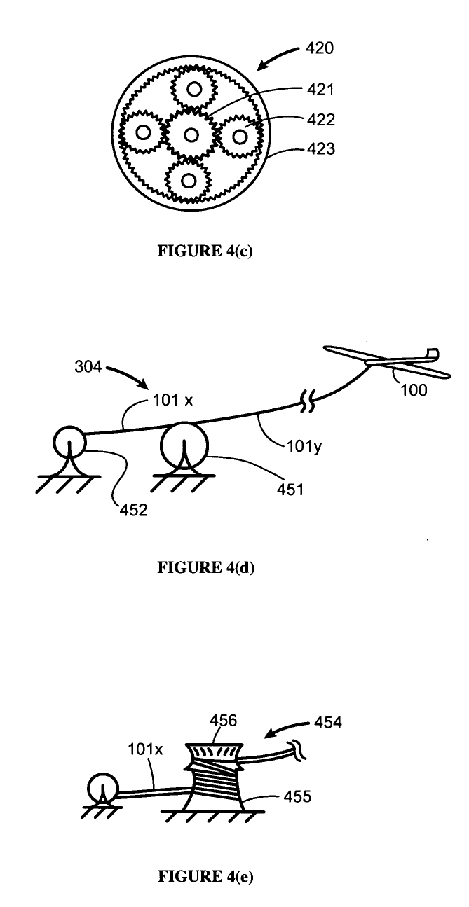

The inventors further consider advanced power generation modules 400 capable of increasing energy generation. In FIGS. 4(a) & 4(b) one such power generator module is shown. The module includes a tether 101 capable of being wound and unwound from a reel element 401 with one end attached to a large kite or craft. As the kite is flown upward away from the module 400, the tether 101 is unreeled turning the reel element 401. The wind power pulling on the craft 101 spins the reel 401. The long tether 101 enables the kite to be flown to high operational altitudes. In certain modes of operation, the craft 100 rotates in a pattern analogous to that of a ground based turbine blade. In common usage this rotational motion is also complemented by a carefully chosen flight pattern designed to maximize energy production. Using any of the kite designs contemplated herein, the inventor points out that very large kites can be used with substantial economies of scale as well as increased energy generation potential. Kite wingspans of 200 and greater are seen as advantageous although less massive kites can be used with great utility.

The reel element 401 is coupled to a drive shaft 402 using a clutch mechanism (schematically depicted as element 403). When the clutch 403 is engaged the reel drives the shaft 402. This is typically, the case when the tether 101 is being reeled out by the flight of the craft. This shaft is operatively engaged with power generation attributes of a generator element 404. One typical arrangement will include magnets and coils arranged to extract electromagnetic energy from the spinning shaft 402. Additionally, the module 400 includes a large flywheel 406 used for storing kinetic energy supplied by the rotating shaft 402. This is a useful attribute because, when the kite is reeled in (using for example a motor 407), the generator typically does not generate energy. Thus, the flywheel can be used to store energy enabling the device to generate energy between the “pulling” or energy generation phase of operation (this is the so-called pull to pull energy storage). This enables a more constant flow of energy to be produced by the system. Additionally, the flywheel can be configured to store energy in greater amounts for even longer periods of time. Thus, such stored energy can be fed onto a power grid at some later time (e.g., during peek energy use periods or periods when the most money can be charged for the energy). In order to not waste the substantial energy accumulated by the system a clutch 404 can be used to decouple the reel element 401 from the shaft 402. For example, the flywheel can be decoupled with the tether when the reel element is used to reel in a desired amount of the tether 101. Additionally, the decoupled flywheel 406 can continue to spin the shaft enabling an uninterrupted stream of energy to be generated even when the kite is reeled in. Such flywheels can be exceedingly large weighing in the range of 20-200 tons in common usage. They can also be made relatively cheaply. In one example, a large concrete flywheel could be used.

In one embodiment, the generator 404 can include a geared shaft that can include a gearing system 410 having a desired gear ratio. For example, a 10:1 gear ratio could enable a relatively low speed turning reel element 401 to transmit a higher rotational velocity to a coil 411 or other electro-magnetic energy generation system. As is appreciated by those of ordinary skill many gear ratios can applied in accord with system needs. Such can be facilitated, for example, by transmission systems and the like. Additionally, if needed the flywheel 406 can be decoupled from the generator 411, for example, using a clutch system 412. In still other alternatives, the flywheel can be dispensed with altogether.

The inventors also point out that that a CVT (constant variable transmission) or an epicyclic transmission can be employed to interface the generator 404, the reel element 401, and the flywheel 406. Both of these transmission types are well discussed in various works on gear and transmission devices. For example, “Gear Drive Systems: Design and Application”, by Lynwander, P., 1983, publ. Marcel Dekker, New York and “Gears and Their Vibration: A Basic Approach to Understanding Gear Noise”, Smith, J. D., 1983, also publ. Marcel Dekker, New York and MacMillan, London.

An attractive feature of epicyclic transmission systems is that they can easily be employed to operate multi-generator systems. For example, FIG. 4(c) provides a simplified depiction of one implementation of an epicyclic gear system 420. Such a system comprises a center “sun” gear 421 surrounded by two or more “planetary” gears 422 which rotate around the sun 421. The outer portion of the “planets” orbit is defined by a geared ring 423 or annulus. This system 420 can be couple with two generators, the flywheel 406, and the reel element 401. There are many possible combinations. For example, in one mode, the flywheel 406 can be operatively coupled with the ring 423 and a generator (generator 1). Also, the reel element 401 can be operatively coupled with the planets 422. And also the sun 421 can be operatively coupled with another generator (generator 2). Alternatively, any of the systems 421, 422, 423 could be coupled with the flywheel 406. The inventors specifically point out that many different operative combinations can be used depending upon how the user wishes to optimize the system. Moreover, the utility of this gearing system is not confined to use of the craft described here. The inventors contemplate its application to windmills as well.

The inventors further consider a two stage reel system 450 as depicted in FIG. 4(d). In such a system, a first stage reel 451 has a single layer winding of tether 101y (i.e., a layer where no portion of the tether overlaps any other or only a small portion of overlap) wound around reel 451. This reel 451 is tethered 101y to the craft 100. Due to the large forces working on the craft 100 a massive amount of tension is applied to tether 101y. The tether portion 101a is referred to as the high tension tether 101a. This high tension tether 101y is vulnerable to increased risk of breakage if the tether is overlapped over itself with numerous overlapping windings. But, because the need for a very long tether is ever present (perhaps between 10-20 miles) and because a single winding can impose significant restraints on the system, a second stage reel 452 is provided. In this second stage the tension is much lower than that of the high tension tether 101a. Accordingly, this tether is referred to as the low tension tether 101x. The primary purpose of the second stage reel 452 is to hold large amounts of tether (generally in many overlapping layers) at a low tension. This low tension tether 101x is played out and taken up by the first stage reel 451 as it reels out the tether 101y. The reel speeds are synchronized so that the rate of tether reeling out (or in) is the same for both reels. Also, the reels can be further supplemented by enabling the reels to change spacing with respect to each other during reeling operation. For example, the second stage reel 452 could be moved closer or further from the first stage reel 451 during operation to maintain the correct rate of reeling and also maintain a desired tension of the low tension tether 101x. Additionally, the inventor contemplates that added power generation apparatus can be operatively connected with the second stage reel 452 if desired.

In another approach one or more of the spools (451, 452) can be replaced by a vertical axis spool and winch system 454 such as is depicted in FIG. 4(e). For example, in one implementation the system 454 can replace the spool 451 of FIG. 4(d). For example, in one embodiment, the second stage reel can be as 452 feeding the tether 101x to the vertical first stage. The tether wraps a single layer around the capstan 455 and then feeds to a spool 456 at the top which may be secured by a cleated or ratchet system and then fed out to the kite 100 using tether portion 101y.

An additional point worth considering is as the size of the kites are so large they can be expected to place a rather large load on the supporting tether and bridle systems used to connect the kites with the power generation apparatus. Moreover, as explained briefly above, in order to stabilize the kites at high altitudes long lengths of tether are required. For example, in one embodiment, the kite is to fly at an altitude of about 1000 meters. This can require a tether of 2000 meters or longer. Thus, the high tensions required in energy generation are further exacerbated by the need for long tethers to maximize the energy generation capabilities of such kites. Such long tethers must overcome a number engineering challenges including the need to sustain the varying tensile forces on the tether as well as aerodynamic considerations over the length of a very long cable (in some cases as long as 17 miles).

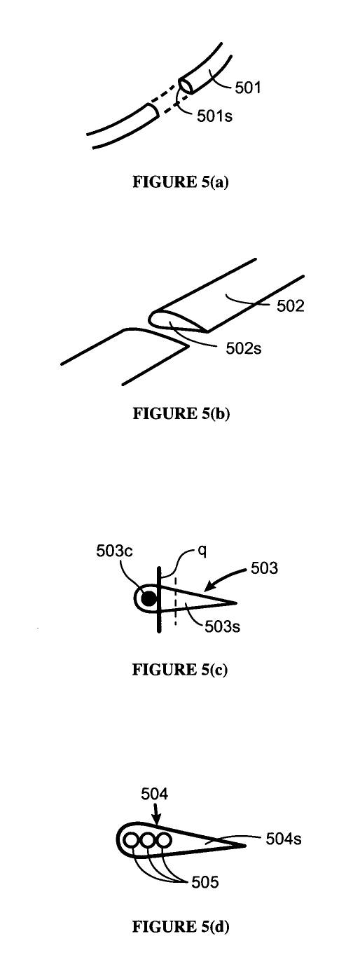

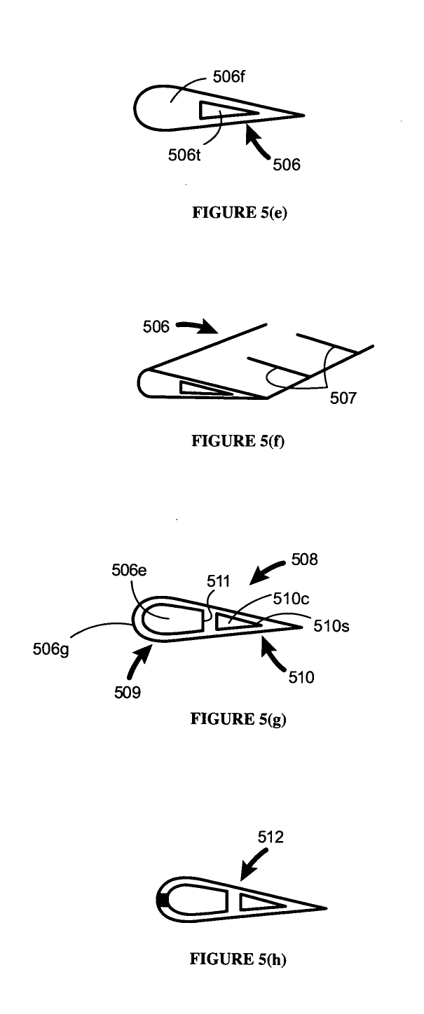

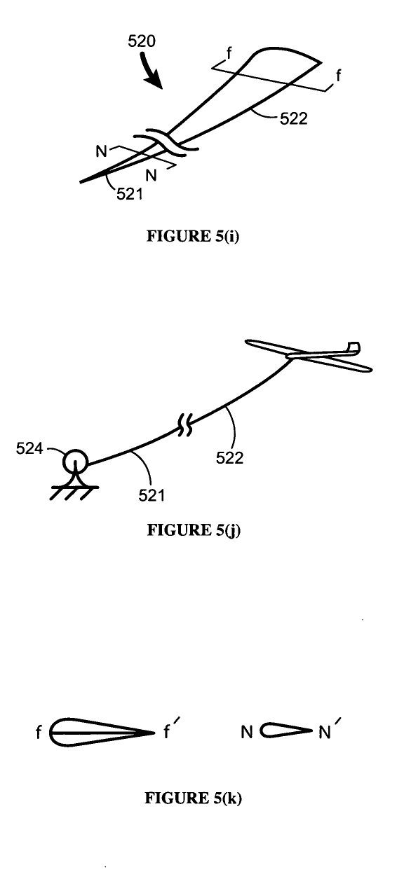

With reference to FIG. 5(a), the inventor has recognized that standard tethers 501 having a circular or cylindrical cross-section 501s exhibit poor aerodynamic performance characterized by high aerodynamic drag and poor stability. The same can be said of bridles that may be used to attach the tether to the craft (kites, gliders, etc). The inventor proposes that tether can be constructed as an inherently stable line or as a dynamically stable line. Additionally, the inventor points out that the tether can comprise as much as 70% of the total drag of the system. In order to address this problem, the tether can de designed with a reduced drag aerodynamic profile. In one embodiment FIG. 5(b) illustrated a tether having a low drag aerodynamic profile. The aerodynamic tether 502 has a cross-section 502s that is shaped like an airfoil. Moreover, the tether 502 is arranged so that the relative wind 503 is directed over the airfoil to generate a very stable tether that is not subject excessive flutter, vibration, and other aerodynamic instability characteristics.

The inventors have discovered a variety of tether embodiments believed to provide improved performance. With respect to FIG. 5(c) the inventors disclose a tether 503 having a cross-section 503s that is configured in airfoil shape. The tether 503 can be formed of a number of lightweight materials including, but not limited to, polyesters, LDPE, polyester foams and a variety of materials which may or may not be structurally reinforced by other materials used in strengthening members. Rugged coatings may also be applied. In this embodiment, a cable 503c is run through a channel in the tether 503. In some embodiments the cable 503c is moved forward of the quarter chord q of the airfoil 503. This cable position may be helpful in minimizing flutter and vibration in the tether.

FIG. 5(d) describes another tether embodiment in which a tether 504 having a cross-section 504s that is configured in airfoil shape. As before, the tether 503 can be formed of a number of lightweight materials which may or may not be structurally reinforced by other materials used in strengthening members. Rugged coatings may also be applied. In this embodiment, a plurality of cables 505 (shown here as three cables) are run through a complementary plurality of channels in the tether 503 (or even one large channel). In some embodiments the cables 505 are generally forward of the center of lift for the tether 504 or even forward of the quarter chord of the tether 504.

In another approach, the inventors have integrated the “cable” into the tether. With respect to FIG. 5(e) the inventors disclose a tether 506 having a cross-section that is configured in airfoil shape. The forward portion 506f of the tether 506 can be a solid material. For example, portion 506f can be a carbon fiber material or an extruded high strength carbon material as well as a range of other strong lightweight materials forming a structure that is very strong, giving remarkable structural strength to the tether 503. Other lightweight structurally strong materials can also be used. A rear or tail portion 506t can be formed with a rigid outer shell surrounding an inner chamber. The chamber can be gas filled (e.g., air) or be filled with a lightweight materials including, but not limited to, polyesters, LDPE, polyester foams and the like. As with other embodiments, rugged coating may also be applied.

FIG. 5(f) shows another embodiment of a tether 506. In this embodiment, the tether includes a number of stress and strain relief features 507 spaced along its length. This with enable various portions of the tether to move (e.g., twist, turn, stretch, expand, vibrate, compress, so on) at various points along its length to enable the tether to accommodate a wide range of stresses over its very long length.

In yet another approach, the inventors have another integrated tether. With respect to FIG. 5(g) the inventors disclose a tether 508 having a cross-section that is configured in airfoil shape. The forward portion 509 of the tether 508 can be formed with a rigid outer shell 509s surrounding an inner chamber 509c. For example, the rigid outer shell 509s can be constructed of a number of materials that have, among other characteristics, high strength to weight characteristics. Suitable materials include, but are not limited to, aramids, para-aramids, carbon fiber materials, UHMWPE's (ultra high molecular weight polyethylene materials). Such materials can include materials like Spectra®, Twaron®, GoldFlex®, Zylon®, Dyneema®, Kevlar®, a carbon fiber materials, extruded high strength carbon materials, multi-layer laminate materials, as well as a range of other strong lightweight materials forming a structure that is very strong, giving remarkable structural strength to the tether 508. Other lightweight structurally strong materials can also be used. A rear or tail portion 510 can be formed with a rigid outer shell 510s surrounding an inner chamber 510c. As with 509s, rigid outer shell 510s can be constructed of the same materials as the shell 509s. Typically, the structures can be integrated into a single outer shell having a center support 511 which can also be made of similar materials. The support 511 can run the entire length of the tether and can be supplemented with many other such supports. As with the prior embodiments, the chambers (509c, 510c) can be gas filled (e.g., air) or be filled with a lightweight materials including, but not limited to, polyesters, LDPE, polyester foams and the like. As with other embodiments, rugged coating may also be applied over the tether 508.

In yet another embodiment FIG. 5(h) depicts a tether 512 having another airfoil-shaped cross-section. In many ways the tether 512 is configured similarly to that of tether 508, i.e., a hard outer shell having inner chambers divided by at least one support. The forward portion of the tether 512 can be weighted 513 to shift the center of mass of the tether forward. This can increase stability and improve “flight” characteristics.

The inventor also contemplates a tether having a size change along its length. For example, as schematically depicted in FIGS. 5(i) & 5(j), a tether having a variable chord length is shown. The inventors point out that in some cases it may be advantageous to have a tether with a narrow chord at the portion 521 closest to the spool 524 and a substantially greater chord width at the portion 522 of the tether closest to the craft. FIG. 5(k) is a depiction of selected tether cross-sections taken near the ground (521) and further up the tether (522) providing one example to the different cambers. The relative ratios of the cambers can be designed in a manner that effectively balances aerodynamic properties, strength, weight considerations, and other relevant properties to yield an optimized tether for the craft chosen and local conditions.

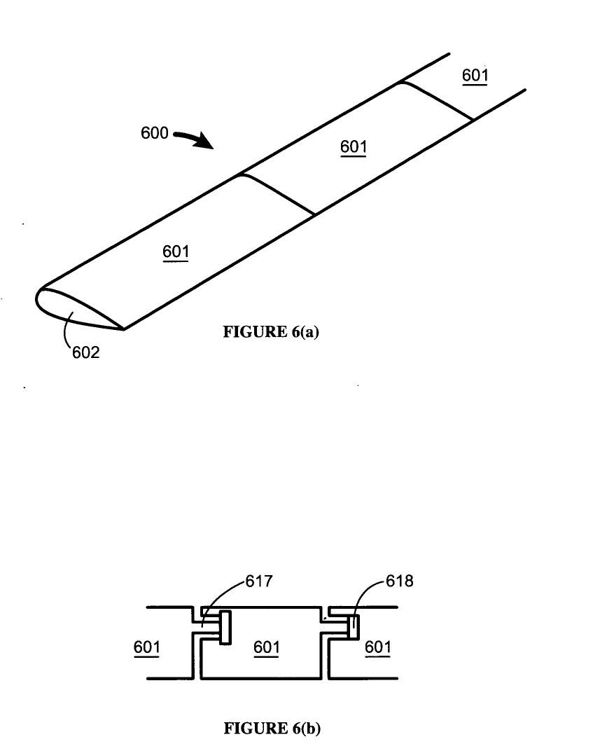

The inventors point out that the tethers of extremely long length make it very difficult to transport the tether. However, when a tether is broken down into a series of more easily transportable segments, transport could be made much easier. For example a tether constructed of a series of 20′-80′ (for example) tether segments linked together has great utility. Such segments can be transported to a desired site and then assembled as need. FIG. 6(a) schematically depicts one aspect of this invention. For example, a series of tether segments 601 can be linked together to form a long tether 600. The tether segments 601 can be of any desired cross-section, but airfoil shaped cross-sections 602 are possessed of certain operational advantages. In one embodiment, schematically depicted in FIG. 6(b), a set of linked segments are schematically shown. Although any type of linking mechanism capable enabling some movement between segments can be used to interconnect the segments 601, the depicted segments have end mounted rods 617 connected with a bearing 618 enabling movement. The idea being to enable the segments 601 to turn about the axis of the tether 600 but not have much translational movement along the length of the tether 600. Great numbers of alternative approaches are contemplated by the inventor. For example, the “rods” can have end mounted ball and socket type joints. One end can have, for example, a spherical bearing into which a connector rod from the adjacent segment 601 is connected. Using these principles, very long tethers can be assembled. For example, in one embodiment, to make a tether 2000 feet long, 50 forty foot segments can be used. Also, a series of 2244 of the same forty foot segments can be connected to create a 17 mile long tether.

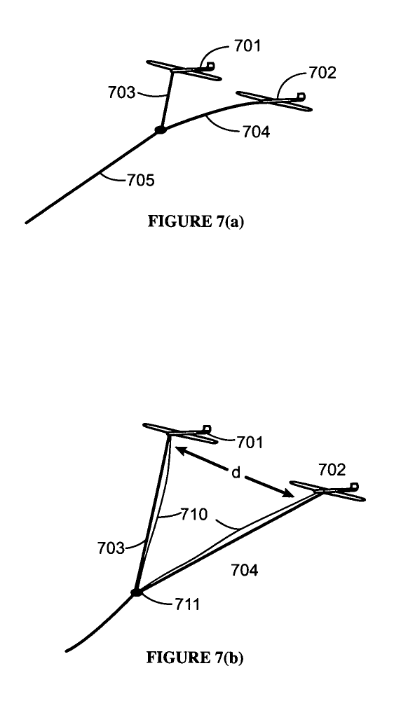

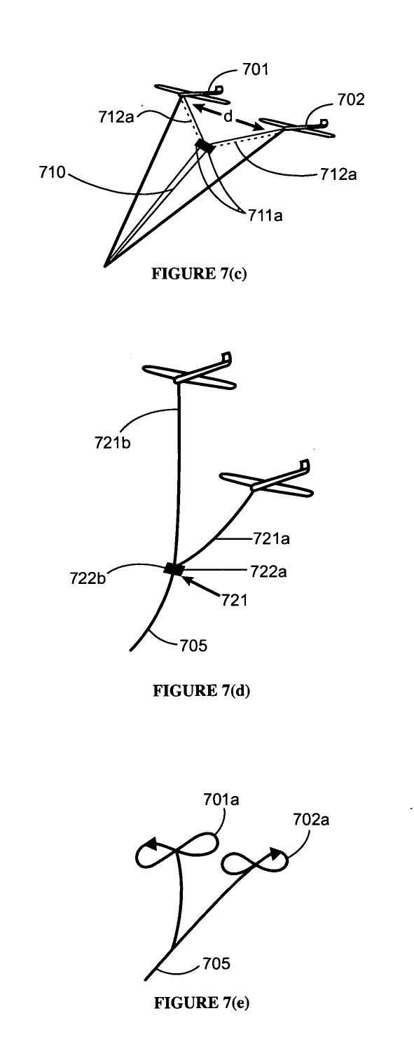

Another tethering approach takes advantage of the strength of such tethers to generate energy using two or more craft. As depicted schematically in FIG. 7(a), aircraft 701, 702 are secured with schematically depicted tether/bridle systems 703, 704 respectively. These systems 703, 704 are attached to a common tether 705 which anchors the craft 701, 702 to the ground. In some embodiments, the tethers are constructed so that the tether lines 703, 704 are aerodynamic and the common tether is not. Also, the entire system can be aerodynamic. In some embodiments, mechanisms can be used to adjust the relative arrangement of the craft with respect to each other.

In one example, FIGS. 7(b) & 7(c) illustrate a mechanism capable of regulating the distance d between co-mounted craft 701, 702. In the depicted embodiment, the craft 701, 702 are tethered together 703, 704 and the distance d is regulated using a control system. The system can comprise a set of supplementary lines 710 with a line attached to each craft 701, 702. An adjustment mechanism 711 can be employed in conjunction with the lines 710 to adjust the flight and positional relationship between the craft 701, 702. For example, the mechanism can be a set of motorized pulleys 711a that crawl up the supplementary lines 710 until the desired distance d₁ can be established between the craft.

Still referring to FIG. 7(c), the system can rely instead on a set of auxiliary lines 712a that can pull the pulleys 711a up the lines 710 toward the craft (or allow them to move away from the craft) to adjust the distance between the craft. In another approach illustrated by FIG. 7(d), a pair of winches 722a, 722b can be mounted at the junction 721 of lines 721a and 721b. The winches 722a, 722b can be used to reel in (or out) the kites 701, 702 independently. This can enable a variety of flight profiles or enable the kites to fly at safe distances from each other. For example, the winches can be used to space the kites 701, 702 apart at a distance that enables both kites 701, 702 to land using the same base tether 705. In a related concept, the winch elements 722a, 722b could be alternatively positioned in the kites 701, 702 themselves.

The multi-kite systems can be flown in a way that minimizes stress on the system. For example, in FIG. 7(e), kites are flown in opposing complementary patterns kites 701a, 702a such that the tether 705 remains relatively stable.

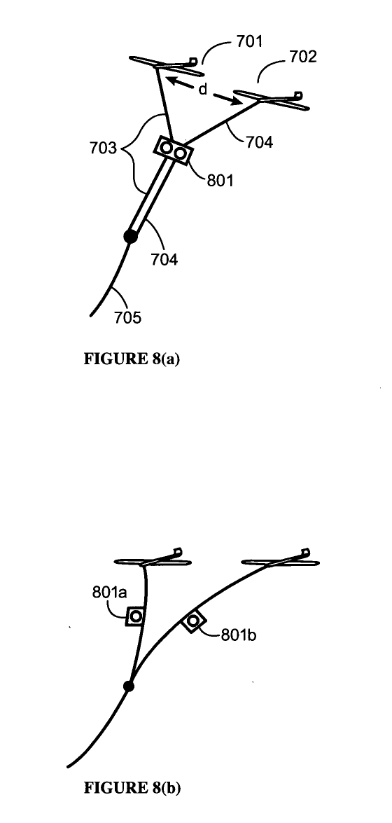

Another example approach is shown in FIGS. 8(a)-8(b), which illustrate a pair of craft 701, 702 anchored to the ground using a tether 705. The auxiliary lines are not needed in this embodiment, nor are the supplementary lines discussed above. A motorized pulley mechanism 801 can be used crawl up and down the depicted tether/bridle systems 703, 704 to set the distance d between the craft. Also, in the event that the craft undergo turbulence, high winds, or other wind conditions, the pulley mechanism 801 can be separated into a pair of pulley components 801a, 801b. In some embodiments such a mechanism 801a, 801b can be moved downward to place the elements 801a, 801b in close proximity and then re-couple them.

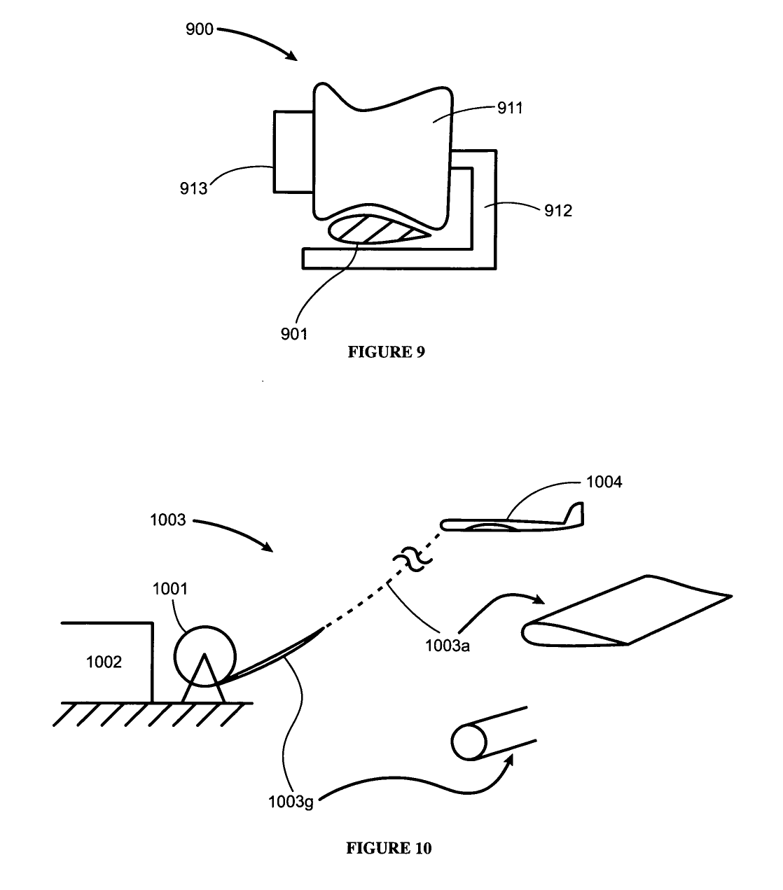

The inventor contemplates that the pulleys employed here (e.g., such as in FIGS. 1, 2, 7 and 8) can be adapted to accommodate aerodynamic tethers, bridles, supplementary lines, auxiliary lines, and so on. For example, as shown schematically in FIG. 9, one such possible pulley assembly 900 is shown. A tether 901 is shown in cross-section clamped between a shaped capstan 911 and a clamp element 912 which provides sufficient clamping tension so that the tether can be crawled by the moving capstan 911. A motor 913 can be used to rotate the capstan 912 to enable it to climb or drop down the tether.

As previously mentioned the dynamic tension on the tether can vary substantially with the highest forces being generated as the tether is played out under high load and with reduced force as the tether is reeled in under substantially reduced load. This variance in load can prove problematic for a number of reasons which will be explained briefly. In one implementation, the tether is wound around a large spool which is played out as the wind pulls the kite down wind. This puts the tether under substantial tension which, in the case of an elastic tether, tightens the tether around the spool. As the tether is progressively spooled out and reeled in the tensions on the spool can steadily increase to the point where the tether can snap with catastrophic consequences. The inventors have constructed a two stage tether with various portions of the tether performing both elastically and also inelastically. As depicted in FIG. 10, a spool 1001 and associated energy generation apparatus 1002 is attached to a two-stage tether 1003 which is attached to the craft 1004. As before, the energy generation apparatus 1002 being capable of generating electrical energy as the tether 1003 is played out. At the “ground portion” of the tether 1003g the tether is constructed of a strong relatively inelastic material such as steel or other associated material having sufficient strength and relatively low elastic modulus (i.e. tensile modulus) preventing excessive tightening around the spool 1001. The “ground portion” of the tether 1003g can be of any length but in one embodiment a length of in the range of about 400-500 m is sufficient, enabling enough distance of spooling out and reeling in to enable efficient energy generation. Additionally, the ground portion can be a standard type of cable having a generally circular cross-section. The remaining “aerodynamic portion” of the tether 1003a is attached to the end of the “ground portion” of the tether 1003g. The aerodynamic portion 1003a has an airfoil shape enabling improved aerodynamic performance in the tether. It can also be configured with sufficient elasticity to provide optimized operational performance. An example of materials that forms a suitable aerodynamic portion 1003a are materials like Kevlar®, Dyneema®, extruded carbon, and others discussed herein, as well as other suitable materials or composites. On the whole such a two stage aerodynamic tether 1003 has better operational performance than a purely steel tether which may be too heavy or a purely elastic tether which may be susceptible to breakage.

The inventors have also understood that the conditions under which a kite operates can have a substantial effect on the amount of energy harvested through the disclosed kite usage. To this end the inventors have come to understand that local atmospheric conditions (such a wind direction, wind velocity and so on) near the kite can have a large effect on energy generation by the kite. As such the kite can be moved into desired positions and altitude to take advantage of the most advantageous wind conditions. Additionally, the various flight properties of each element of the system can be monitored and adjusted to provide a desired system performance. To that end sensors mounted on the various elements of the system (See, e.g., FIGS. 1(a) & (b)) can be coupled to a control system that received inputs from weather detection systems that can measure and/or forecast weather and wind conditions in the flight area. For example, ground control stations can make use of RADAR or other wind detection systems to characterize local wind, weather, and other atmospheric conditions in the general area of the kite. The inventor also understands that many systems can be used to characterize local weather and wind conditions in accordance with the principles of the invention. Examples of detection systems suitable for such uses include, but are not limited to LIDAR (Light Detection and Ranging), SODAR (SOnic Detection And Ranging), wind profilers, and other suitable technologies. Additionally, other sensor systems mounted on the craft, on the bridle, and on the tether can provide input to the control systems. Using information obtained from such devices control input information can be obtained. Additionally, a wide range of small sensors can be attached to the kite, bridle, and tethers to provide an extraordinary range of control inputs. Accelerometers, altimeters, stress and strain gauges, GPS units, inertial units, wind sensors, and numerous other sensors can be used to provide control system inputs. Using information obtained from such devices, the kite can be adjusted to set optimal altitude, position, heading, pitch, yaw, roll angle, angle of attack, tether length adjustments, tether tension, tether angle, tether extension or retraction rates, and also to generate a desired flight pattern or energy generation pattern for the kite. Thus, in general, the ground stations can include a detector system for characterizing wind and/or weather conditions and a control system capable of affecting the flight characteristics and flight performance of the kites. These systems can be further supplemented by sensors mounted on the tether and bridle systems of the kite as well as sensors on the kites themselves. For example, air pressure sensors and strain gauges mounted on the craft or the tether/bridle can provide useful input for such control systems. These sensor systems can be used to adjust for changing weather conditions. For example weather forecasting can be used be used to make flight adjustments well before the actual weather conditions change. Also, such forecasting can be used to provide power grid operators advanced notice of power surges or drop offs in power generation.

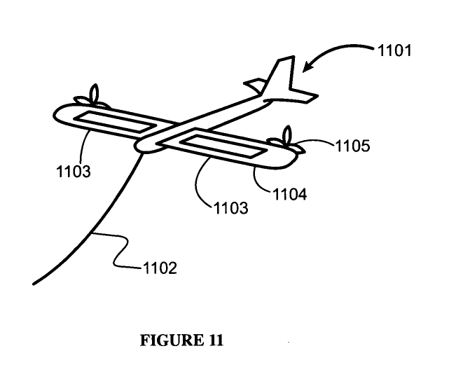

The inventors contemplate that the many systems mounted on the craft of the invention will need power. In some embodiments, power can be provided by a ground station and then connected to the craft using a conductive portion of the tether or an alternative power transmission means. However, the applicants also contemplate that such power can be generated on the craft. Some approaches are described with respect to FIG. 11. A craft 1101 is tethered 1102 to the ground using any suitable approach (including, but not limited to approaches disclosed in this document). On board power can be generated using, for example, large on board solar panels. In this embodiment, solar panels 1103 can be mounted on the upper wing 1104 surfaces as well as other locations. The power generated can be stored in on-board aircraft battery of storage systems (not shown in this view). Alternatively, although not preferred, the power could be stored elsewhere (e.g., in ground-based storage systems). Alternatively/additionally, small wind powered turbines 1105 can be used to generate energy. This approach is attractive because it does not necessarily vary with the time of day as solar cells do. The wind powered turbines 1105 can be mounted to the craft at many locations. In one attractive implementation, the turbines 1105 can be mounted at the wing tips to take advantage of the wing tip vortices. Although this concept is disclosed referencing specific embodiments, the inventors do not intend to be limited only to the depicted embodiments.

The present invention has been particularly shown and described with respect to certain preferred embodiments and specific features thereof. However, it should be noted that the above-described embodiments are intended to describe the principles of the invention, not limit its scope. Therefore, as is readily apparent to those of ordinary skill in the art, various changes and modifications in form and detail may be made without departing from the spirit and scope of the invention as set forth in the appended claims. Other embodiments and variations to the depicted embodiments will be apparent to those skilled in the art and may be made without departing from the spirit and scope of the invention as defined in the following claims. Also, reference in the claims to an element in the singular is not intended to mean “one and only one” unless explicitly stated, but rather, “one or more”. Furthermore, the embodiments illustratively disclosed herein can be practiced without any element which is not specifically disclosed herein.

What is claimed is:

1. An energy generation system configured to capture wind energy, the system comprising:
a plurality of aircraft configured to be positioned in air currents enabling the capture of wind energy;
a tether system that anchors the aircraft when they are airborne;
a power system that enables one of:
(i) the harvesting of wind energy from the aircraft transmitted through the tether to the power system, or
(ii) the capture and transmission of electrical energy generated by the aircraft; and
a control system enabling control of the aircraft and optionally other elements of the system.

2. The system recited in claim 1 wherein each of the plurality of aircraft are operatively tethered to the tether.

3. The system of claim 2 wherein the tether includes a mechanism for adjusting the distance between the plurality of aircraft.

4. The system of claim 1 wherein the plurality of aircraft consist of two aircraft coupled to the tether and arranged to cooperatively apply wind generated force on the tether.

5. The system of claim 3 wherein the mechanism for adjusting the distance between the plurality of aircraft comprises a motorized pulley device.

6. The system of claim 5 wherein the motorized pulley device can be separated into a plurality of disengageable components to rapidly increase the distance between the plurality of aircraft.

7. An energy generation system configured to capture wind energy, the system comprising:
an aircraft configured to be positioned in air currents enabling the capture of wind energy;
a tether system that anchors the aircraft when it is airborne;
a power system that enables one of:
(i) the harvesting of wind energy from the aircraft transmitted through the tether to the power system, or
(ii) the capture and transmission of electrical energy generated by the aircraft;
a launch and retrieval system for the aircraft; and
a control system enabling control of the aircraft and optionally other elements of the system.

8. The system recited in claim 7 wherein the launch and retrieval system for the aircraft comprises an elevated platform suitable for launching the aircraft.

9. The system recited in claim 8 wherein the elevated launch platform can be angled upward to facilitate improved launching of the aircraft.

10. The system recited in claim 8 wherein the elevated launch platform can be returned to a horizontal configuration to facilitate improved landing of the aircraft.

11. The system recited in claim 8 wherein the aircraft is accelerated off the elevated platform by forces applied to the aircraft by a launch mechanism.

12. The system recited in claim 11 wherein the aircraft rests on a temporary movable cart during launch.

13. The system recited in claim 11 wherein the launch mechanism comprises a catapult mechanism.

14. The system recited in claim 11 wherein the launch mechanism comprises a pull line attached to the aircraft wherein the pull line is moved in a manner that accelerates the aircraft to a suitable launch velocity.

15. An energy generation system configured to capture wind energy, the system comprising:
an aircraft configured to be positioned in air currents enabling the capture of wind energy;
a tether system that anchors the aircraft when it is airborne;
a power system that enables one of:
(i) the harvesting of wind energy from the aircraft transmitted through the tether to the power system, or
(ii) the capture and transmission of electrical energy generated by the aircraft; and
a control system enabling control of the aircraft and optionally other elements of the system,
wherein the aircraft includes a tether attachment site for attaching the aircraft to the tether and a tether positioning system configured to enable changes in the flight profile of the aircraft by adjusting the position of the attachment site.

16. The energy generation system recited in claim 15 wherein the aircraft includes a bridle attached to the aircraft and a movable attachment site that is movable across a portion of the bridle enabling changes in the flight profile of the aircraft by adjusting the position of the attachment site.

17. The energy generation system recited in claim 16 wherein the aircraft includes an airfoil having wingtips and wherein the bridle is attached to the airfoil enabling changes in the flight profile of the aircraft by adjusting the position of the attachment site.

18. The energy generation system recited in claim 17 wherein the bridle is attached to the airfoil inward from the wingtips of the airfoil.

19. The energy generation system recited in claim 15 wherein the tether positioning system includes a bridle attached to the tether, the bridle engaged with a pitch control mechanism for adjusting the pitch angle of the aircraft.

20. The energy generation system recited in claim 19 wherein the pitch control mechanism is arranged to move at least one end of the bridle to adjust the position of the tether relative to a center of lift for the aircraft to enable adjustment of the pitch angle of the aircraft.
